(19) United States
(12) Patent Application Publication
(10) Pub. No.: US 2006/0055331 A1
(43) Pub. Date: Mar. 16, 2006

(54) Light-transmitting substrate provided with a light-absorbing coating as well as a method of preparing a light-absorbing coating

(75) Inventors: Remy Cyrille Broersma, Mainvilliers (FR); Hendrik-Jan Dreuning, Eindhoven (NL); Rene Jan Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/534,473

(22) PCT Filed: Oct. 27, 2003
(86) PCT No.: PCT/IB03/04753

§ 371 Date: May 10, 2005

(30) Foreign Application Priority Data
Nov. 14, 2002 (EP) 02079742.9
Jan. 13, 2003 (EP) 03075078.0

(51) Int. Cl. H01J 61/35; H01J 17/16

(52) U.S. Cl. 313/635

(57) ABSTRACT

Disclosed is a light-transmitting substrate that is at least partly provided with a light-absorbing coating. The light-absorbing coating comprises stabilized pigments, which are incorporated in a sol-gel matrix. The coating at least comprises an organic pigment and that an aminosilane is present in order to stabilize the pigments. Moreover, an electric lamp comprising a light-transmitting lamp vessel that accommodates a light source is disclosed. Said lamp vessel comprises the above light-transmitting substrate.

The present invention relates to a light-transmitting substrate that is at least partly provided with a light-absorbing coating, said light-absorbing coating comprising stabilized pigments which are incorporated in a sol-gel matrix. The invention further relates to an electric lamp comprising a light-transmitting lamp vessel that accommodates a light source, wherein said lamp vessel comprises the above light-transmitting substrate. Furthermore the present invention relates to the light absorbing coating itself.

Light-transmitting substrates provided with a light absorbing coating can be used as a color layer on or in front of (incandescent) lamps for general lighting purposes. The substrate may comprise, for example, a colored filter made of a piece of glass, which is flat or non-flat and which is designated to be placed on trajectory of light, said light being generated by a lamp. Such application is often used in outdoor lighting. Another example of a light-transmitting substrate is a lamp vessel that is placed over a light source of an electric lamp. Such electric lamps are predominantly used as indicator lamps in vehicles, for example as red-colored light source in red tail and brake lights of automobiles. Said electric lamps can also be used in traffic lights.

An electric lamp of the type mentioned in the opening paragraph is known from WO 01/20641 as filed by the present applicant.

The electric lamp according to WO 01/20641 is provided with an optically transparent, non-scattering, light-absorbing coating in which pigments are incorporated in a sol-gel matrix and which can resist temperatures up to 400° C. The sol-gel matrix in which the pigments are incorporated can reach a maximum layer thickness of about 500-800 nm when tetraethoxy silane (TEOS) is used as a sol-gel precursor and a maximum layer thickness of about 2-3 μm when methyltrimethoxy silane (MTMS) is used as a sol-gel precursor.

According to WO 01/20641 the pigments are stabilized by means of an organic polymer. Depending on the curing temperature said polymers partly disappear from the coating in the curing treatment and may further burn out during the operation of the lamp when high temperatures are reached. This leads either to shrinkage of the coating layer or to an increased porosity thereof or to a combination of both.

It is an object of the invention to provide an electric lamp according to the preamble, wherein the above drawbacks have been obviated. Moreover, it is an object to provide in particular for a red colored coating that can be applied in an automotive luminaire. Furthermore it is an object of the invention to provide for a lamp vessel that is fit for said electric lamp.

To this end the electric lamp according to the preamble is characterized in that the coating at least comprises an organic pigment and that an aminosilane is present in order to stabilize the pigments.

The use of an aminosilane as a stabilizer for the pigment leads to a strong reduction of the organic fraction in the layer, which results in a lamp coating which does not change during lifetime. Moreover, the mechanical properties of the coating are improved as a chemical bond is formed between the pigment particles and the sol gel network.

As aminosilane hardly takes up any volume in the layer at the quantities required, it is possible to make coatings containing a higher particle volume fraction. This is contrary to the situation in which organic stabilizers are used, as the latter take up a very large volume.

In the automotive industry, it is desired to have a rear luminaire with a colorless filter and colored lamps, i.e. stop and tail lamps and blinking lamps. Amber colored blinking lamps already exist. However, it is very difficult to provide for a red colored lamp with acceptable color point stability. In order to have a high initial lumen output, organic pigments are needed in the coating. Generally, organic pigments give a relatively high lumen output on lamps, but have low temperature stability. On the other side, inorganic pigments give a relatively low lumen output, but have higher temperature stability.

By adding aminosilane to the coating the temperature stability thereof is significantly improved. The aminosilane has an anti-oxidizing ability, which has a positive effect on the stability of the organic pigments in the coating.

In a particular embodiment, x-alkyl-aminopropyltrialkoxysilane is used as a stabilizer, where the alkyl group can be a methyl-, ethyl- or phenylgroup, and where the alkoxygroup can be a methoxygroup or an ethoxygroup.

Preferably, a (N,N-dimethylaminopropyl)trialkoxysilane, such as in particular (N,N-dimethylaminopropyl)trimethoxysilane or (N,N-dimethylaminopropyl)triethoxysilane, is used as a stabilizer.

In an advantageous embodiment, the coating comprises both an organic and an inorganic pigment.

In this way an optimal effect is achieved, i.e. a high lumen output and a high temperature stability.

As an advantageous example of an organic pigment for red colored coatings Cromophtal A2B can be mentioned. An example of a particular inorganic pigment for the above application is Fe₂O₃.

In a particular embodiment, aluminum oxide is added to the coating during preparation thereof.

By adding aluminum oxide to the pigment dispersion during preparation thereof, the aluminum oxide acts as a grinding aid. This results in a smaller particle size distribution of the pigments, which results in a reduction of the scattering of the coating. Moreover, the aluminum oxide also acts as a stabilizer for the pigments in the coating. The aluminum oxide prevents pigments to agglomerate during the application and curing process. Another effect of the addition of aluminum oxide to the pigments in the coating is that the temperature stability thereof is significantly increased. The colorpoint shift of lamps without aluminum oxide in the coating is larger than the colorpoint shift of lamps with aluminum oxide in the coating.

The present invention also relates to an electric lamp comprising a light-transmitting lamp vessel that accommodates a light source. Said lamp vessel comprises a light-transmitting substrate according to the above.

In this case at least part of the lamp vessel is provided with the above light-absorbing coating.

As mentioned in the above, said electric lamps can advantageously be used as indicator lamps in vehicles, for example as red-colored light source in red tail and brake lights of automobiles.

Moreover, the present invention relates to a light absorbing coating according to the above, as well as a lamp vessel provided with such a light absorbing coating.

These and other aspects of the invention will be apparent from and elucidated with reference to the embodiments described hereinafter.

In the drawings:

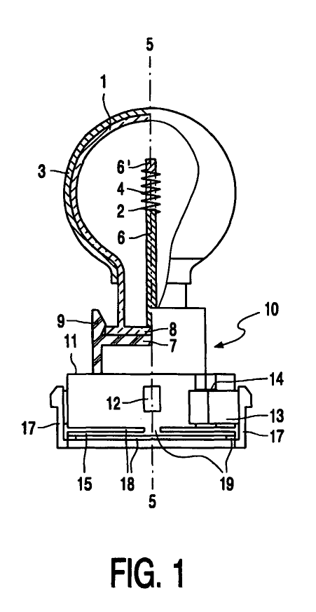

FIG. 1 is a side view, partly cut away and partly in cross-section, of an electric lamp in accordance with the invention comprising a lamp cap; and

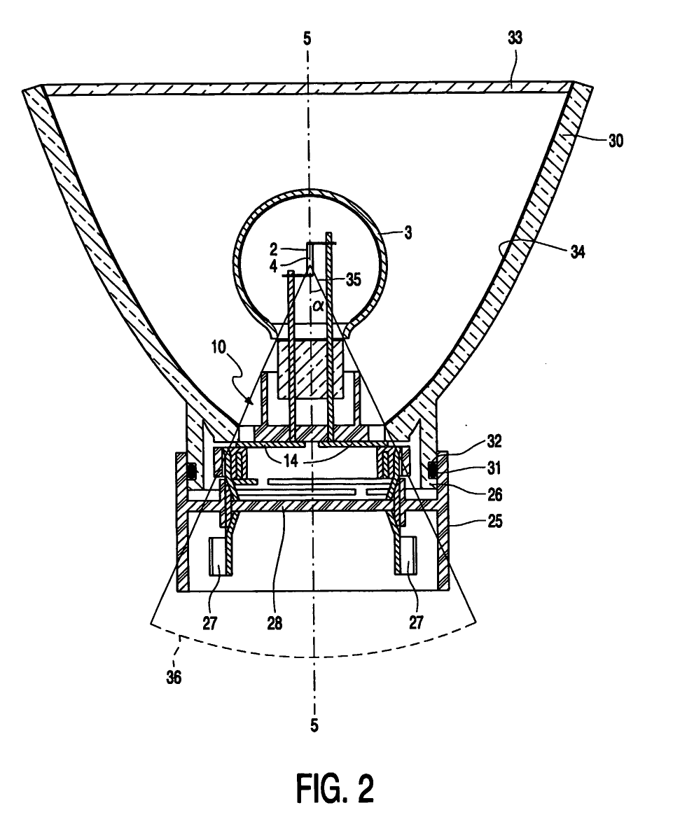

FIG. 2 shows an electric lamp provided with a reflector and an adapter.

The Figures are purely schematic and not drawn to scale. Particularly for clarity, some dimensions are exaggerated strongly. In the Figures, like reference numerals refer to like parts whenever possible.

FIG. 1 shows an electric lamp in accordance with the invention, a part of which is shown in side view, partly cut away, and another part of which is shown in cross-section. The electric lamp comprises a light-transmitting lamp vessel 1, for example made of glass, which is closed in a gastight manner and in which an electric element 2, being a (spiral-shaped) tungsten incandescent body with a center 4 in the Figure, is axially positioned on an axis 5 and is connected to current conductors 6 which issue from the lamp vessel to the exterior. The lamp shown has a filling of an inert gas, for example an Ar/Ne mixture, with a filling pressure slightly above 5 bar.

A lamp cap 10 is firmly connected to the lamp vessel 1. The lamp cap 10 has a synthetic resin housing 11. The housing 11 comprises a flat base portion 7 at least substantially perpendicular to the axis 5. The lamp vessel 1 is closed off in a gastight manner by means of a plate 8 of an insulating material, which plate lies in a plane at least substantially perpendicular to the axis 5. Electric element 2 is mounted in a previously defined position with respect to the plate 8 during the manufacture of the lamp. The plate 8 of the lamp vessel 1 is pressed home against the base portion by locking means 9, for example ridges, such that the electric element 2 will enter a previously defined position with respect to the reference means 12, for example studs. The studs 12 form part of the lamp cap and are designed to abut against a support 30, for example a reflector, as is visible in FIG. 2.

The lamp cap also comprises contact members 14 which are provided with a screen 13 and to which the current conductors 6 of the lamp vessel 1 are connected. A resilient intermediate portion 15, which is provided with coupling means 17, resilient tags in the Figure designed for coupling the reflector to the lamp cap, forms an integral whole with the housing 11. The resilient action of the intermediate portion is obtained in that the intermediate portion is made so as to be hollow, so that no more than a wall remains as the intermediate portion, whereupon a major portion of the wall is removed by means of two grooves 18 which run perpendicularly to the axis 5. The remaining portion of the wall forms a bridge 19, which is rotated, near the next groove, through an angle of, for example, 180° about the axis 5.

The lamp vessel 1 of the electric lamp has a relatively small axial dimension of approximately 22 mm and is suitable for consuming a relatively high power of, for example, 5 to 25 W. The electric lamp has a service life of approximately 6000 hours in this case.

In accordance with the invention, at least a part of the lamp vessel 1 is covered with a light-absorbing coating 3 having an average thickness of 2-3 μm.

FIG. 2 shows the electric lamp provided with a support 30, being a reflector with a transparent plate 33 in the drawing, as well as with an adapter 25. In this configuration of a lamp with an adapter and a reflector, where the reflector is provided with a rubber ring 31 retained in a groove 32, the rubber ring seals off the opening 26 between the lamp cap and the reflector in a gastight manner. The adapter is provided with standardized contact points 27 which are passed through the bottom plate 28 of the adapter in a gastight manner and are connected to contact members 14 of the lamp cap 10.

It is visible in the drawing that the lamp cap 10 falls substantially entirely within a cone 36 which has its apex 35 in the center 4 of the electric element 2 and has an apex half angle α of 25°. The light originating from the electric element 2 can reach the reflecting surface 34 substantially without obstruction and is reflected there at least substantially axially in the direction of the transparent plate 33.

1. A light-transmitting substrate which is at least partly provided with a light-absorbing coating, said light-absorbing coating comprising stabilized pigments which are incorporated in a sol-gel matrix, characterized in that the coating at least comprises an organic pigment and that an aminosilane is present in order to stabilize the pigments.

2. A light-transmitting substrate as claimed in claim 1, characterized in that x-alkyl-aminopropyltrialkoxysilane is used as a stabilizer, where the alkyl group can be a methyl-, ethyl- or phenylgroup, and where the alkoxygroup can be a methoxygroup or an ethoxygroup.

3. A light-transmitting substrate as claimed in claim 1, characterized in that the coating comprises both an organic and an inorganic pigment.

4. A light-transmitting substrate as claimed in claim 1, characterized in that aluminum oxide is added to the coating during preparation thereof.

5. An electric lamp comprising a light-transmitting lamp vessel that accommodates a light source, said lamp vessel comprising a light-transmitting substrate according to claim 1.

6. Light absorbing coating according to claim 1.

7. Lamp vessel provided with a light-absorbing coating, the light-absorbing coating comprising stabilized pigments which are incorporated in a sol-gel matrix, characterized in the coating at least comprises an organic pigment and that an aminosilane is present in order to stabilize the pigments according to claim 1.
